(19) United States
(12) Patent Application Publication
(10) Pub. No.: US 2023/0286100 A1
(43) Pub. Date: Sep. 14, 2023

(54) Stump Grinder Tooth Sharpening Tool and System

(71) Applicant: Glenn Welch, Belmont, NH (US)

(72) Inventor: Glenn Welch, Belmont, NH (US)

(21) Appl. No.: 17/690,543

(22) Filed: Mar. 9, 2022

(51) Int. Cl. B24B 3/36; B24B 23/02; B23D 63/14

(52) U.S. Cl. CPC B24B 3/363; B24B 23/02; B23D 63/14

(57) ABSTRACT

A sharpening tool for dull stump grinder teeth including a head extending from a shaft, where the shaft is sized for use with the chuck of a rotating power tool. The top face of the head is coated with an abrasive material, such as diamond grit, and is preferably slightly convex.

### FIELD OF THE INVENTION

The present invention relates to sharpening tools, and in particular, to an easy-to-use tool for sharpening and the teeth of stump grinder teeth.

### BACKGROUND

Once a tree has been felled, there is often a need for the stump of the tree to also be removed. Tools for stump removal exist. Referring to FIG. 1, for example, stump grinder 100 uses stump grinder wheel 102 to grind stumps. The stump grinder 102 shown is sold under the brand DR, and it is understood that many similar products are on the market. Referring to FIGS. 2a-2c, several examples of stump grinder wheels 102 separated from stump grinder 100 are provided. The wheels 102 shown are sold under the brand Green Manufacturing, and it is understood that many similar products are on the market. Each stump grinder wheel 102 includes a number of teeth 104. Now referring to FIGS. 3a-3c, various teeth 104 with teeth heads 108 are provided. The heads 108 of such teeth 104 are likely precision ground carbide and brazed onto the bodies of teeth 104. The teeth 104 are spun on the wheels 102 at great speed against the stumps and are therefore doing the real work of the stump grinding. The head 108 of each tooth 104 will be forcefully set at the stump thousands of times during each stump removal. Especially given that many stumps are made of hard wood, it is inevitable that the teeth heads 108 will become dull after extended use. This requires either replacement or sharpening of the teeth 104. Although not apparent from FIG. 3a, it is understood that the heads 108 of some teeth 104 are not flat but are instead concave in toward the body of the tooth 104. This concavity is, in fact, the most common configuration. The concave condition, also known as “tool relief” or “tool rake,” allows for a thinned cross section at the cutting edge of the tooth, which provides a better cut and better ability to move cut material out of the way.

Now referring to FIG. 4, a stump grinder tooth sharpener 106 is provided. The sharpener 106 shown is sold under the brand DeWalt, and it is understood that many similar products are on the market. This sharpener 106 cannot be used in the field and requires bolting to a fixed surface, like a bench. In addition, the flat wheel used with this sharpener 106 will not allow a tool relief or rake to be put on the carbide cutting surface. U.S. Pat. No. 4,863,769 to Ronald Dreiling discloses another stump grinder tooth sharpening apparatus. This apparatus is mountable onto a wheel 102 but it is a complicated apparatus and may not be usable in all field situations. Therefore there is a need for a simple, field-ready tool for sharpening dull stump grinder teeth without the need to remove them from the stump grinder wheel, thereby saving time and money.

### SUMMARY OF THE INVENTION

The present invention is a sharpening tool and sharpening system. While the present invention was designed to sharpen dull stump grinder teeth, one of at least ordinary skill in the art will recognize that the present invention may be used in other applications as well.

In its most basic form, the sharpening tool of the present invention is a shaft extending from a head. The head has a top face coated in an abrasive material; a bottom face, out of which the shaft extends from the center; and a body extending between the top face and the bottom face. The shaft and head are preferably manufactured from a stainless material that will not rust, such as SAE 304 stainless steel. Other steel alloys, such as 4140 or 1018 steel alloy, or other materials commonly used in the art of rotating tools and on to which abrasive material may be disposed, may be used to achieve similar results, but are not preferred. In some embodiments, the shaft and the head are made of different materials.

It is preferred that the abrasive material be diamond grit with a size between 30 and 50 mesh, and preferably 40 mesh. The preferred 40 mesh size corresponds to a grit size of 430-570 μm in diameter. It is also preferred that the top face of the head be domed convex away from the round body. In other words, it is preferred that the top face bulge out slightly from the body. In some embodiments, however, the top face is flat. The preferred convexity allows for better sharpening of those stump grinder tooth heads that are slightly concave. In addition to their other disadvantages, prior art stump grinder tooth sharpeners often cannot get to this concave surface and therefore only sharpen the edges of the tooth. Moreover, the concave surface often wears away with continued use of the tooth and the convexity of the sharpening tool's top face can restore the concavity to the tooth. In preferred embodiments, the bottom face is flat. In some embodiments, however, the bottom face has a substantially conical surface so that the body of the head is cone-shaped.

As used herein, “substantially conical” means that the bottom face may be perfectly conical such that the shaft connects to the bottom face at the narrowest part of the cone and the cone ends at its widest point with the top face. It could also mean that the shaft meets the center of the bottom face at the cone's narrowest point, the cone extends outward to its widest point, and then extends further to meet the top face without widening further. It could also mean that the bottom face widens from the center out to the wider diameter of the top face, but the widening is not necessarily linear, but may be a more rounded bulging. It may also mean that the bottom face has some ridging so that it is not perfectly smooth, but does widen generally like a cone from the center where it meets the shaft to the top face. In all interpretations of the phrase, “substantially conical,” the shape of the bottom face is at its narrowest at the center of the bottom face where the bottom face intersects the shaft and at its widest where the bottom face meets the top face. And in all interpretations of the phrase, “substantially conical,” the widest point of the conical shape is never wider than the face diameter of the top face.

The shaft is preferably a narrow cylinder attachable to a rotating power tool. In the preferred embodiment of the system, the shaft has a cylindrical shape and is gripped by the collet of a rotary power tool in the same manner as the collet would grip a sanding disc, for example. In other embodiments, however, the shaft may take other art-recognized forms, such as having a hexagonal cross section for attachment to a quick connect hex driver, such as those found on drywall screw guns. Regardless of how it is shaped or gripped, the shaft of the sharpening tool is rotated rapidly when the rotary power tool is energized in the same manner as a sanding disc would be when mounted within the collet of a rotary power tool.

The preferred shaft is between 1.15 and 1.35 inches long, and preferably 1.25 inches. The preferred shaft has a shaft diameter of between 0.2 and 0.3 inches, and preferably 0.25 inches, which allows it to be gripped by collets of most conventional rotary power tools. The shaft may include some ridging, reinforcement, or other structural support at its intersection with the center of the bottom face of the head. The shaft is preferably attached to the head by brazing. In some embodiments, however, the shaft and head are machined from a single bar of material. In embodiments in which the shaft is brazed to the head, the full length of the sharpening tool is preferably approximately 1.58 inches.

The head of the sharpening tool is preferably a short wide cylinder when compared to the shaft. The body of the head preferably has a round cross section and extends between the top and bottom faces. The shaft extends from the center of the bottom face of the head. The top face is preferably round and has a face diameter of between 0.75 and 1.25 inches, and preferably 0.98 inches. The preferred round body also has a width that is measured between the top and bottom faces. Depending on the materials used, the width may be quite nominal so that the round body appears to be more like a rounded disc with abrasive coating on the top face. If the bottom face is substantially conical, then the body of the head is cone-shaped, as discussed above.

In its most basic form, the sharpening system of the present invention includes a rotating or rotary power tool and a sharpening tool of the present invention, as described above. It is worth emphasizing that these power tools, and therefore the sharpening system of the present invention, are portable. The problems discussed above, of prior art being difficult to use in the field, are therefore resolved herein. It is preferred that the rotary power tool operate at a high speed, such as 10,000 RPM or greater, but lower speed rotary tools may also be used in the sharpening system of the present invention. A preferred rotary power tool in the sharpening system of the present invention is a high speed die grinder, whether powered electrically through a cord, pneumatically using an air compressor, or battery-operated. The die grinder typically has a collet, usually a ¼″ collet, which, when tightened, tightly grabs the shaft of the sharpening tool. The collet of the die grinder is the part that normally holds a sanding disc and spins when the grinder is in use. The shaft is gripped by the collet just as the collet would grip a sanding disc. In this way, the shaft of the sharpening tool is spun rapidly when the grinder is in use, just as a sanding disc would be. Another rotating power tool that may be used with the sharpening system of the present invention is a handheld drill that includes a chuck, to which the shaft of the sharpening tool is attached, such as a portable power drill with low RPMs. If a handheld drill is used in the sharpening system of the present invention, the shaft of the sharpening tool is gripped by the chuck of the drill in the same way that the drill would typically grip a drill bit. A single sharpening tool is preferably used with high speed rotary power tools, such as die grinders, but may also be used with low speed rotary power tools, such as power drills.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a perspective view of a prior art stump grinder.

FIGS. 2a-2c are perspective views of three prior art stump grinder wheels used with prior art stump grinders of the type shown in FIG. 1.

FIGS. 3a-3c are perspective views of three prior art teeth used with stump grinder wheels of the type shown in FIGS. 2a-2c.

FIG. 4 is a perspective view of a prior art stump grinder tooth sharpener.

FIGS. 5a and 5b are top down and side views of the sharpening tool of the present invention.

FIGS. 5c-5f are side views of alternate embodiments of the sharpening tool of the present invention.

FIGS. 6a and 6b are perspective views of a sharpening tool of the present invention and a tooth to be sharpened.

FIG. 7a is a side view of a sharpening tool of the present invention attached to a handheld drill.

FIG. 7b is a side view of a sharpening tool of the present invention attached to a handheld die grinder.

### DETAILED DESCRIPTION

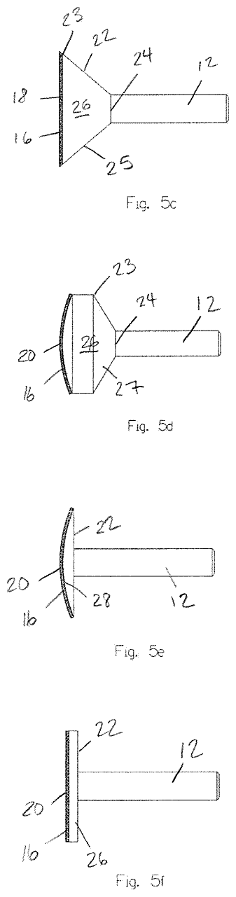

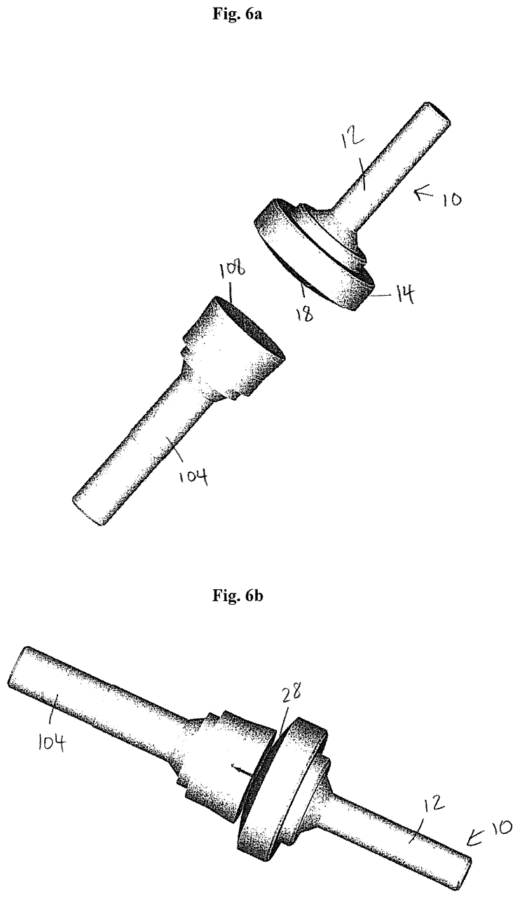

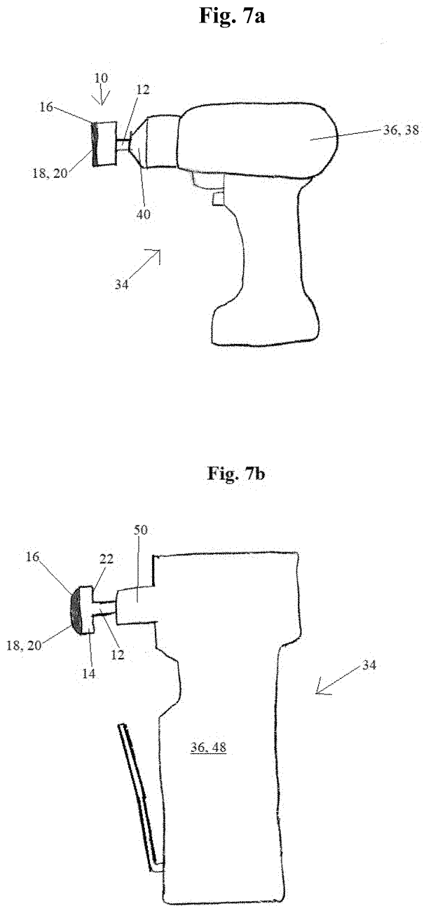

Referring first to FIGS. 5a, top down and side views of sharpening tool 10 of the present invention are provided. Sharpening tool 10 is a shaft 12 extending from a head 14. The head 14 has a top face 16 coated in an abrasive material 18; a bottom face 22, out of which the shaft 12 extends from the center 24; and a round body 26 extending between the top face 16 and the bottom face 22. The shaft 12 and head 14 are preferably manufactured from SAE 304 stainless steel. Abrasive material 18, shown emboldened, is preferably diamond grit 20 with a size between 30 and 50 mesh, and preferably 40 mesh. The preferred top face 16 is shown with convexity 28. Convexity 28 causes top face 16 to dome convex away from the body 26. In some embodiments, such as that shown in FIGS. 5c, 5f, and 7a, however, the top face 16 is flat. The preferred convexity 28 allows for better sharpening of those stump grinder tooth heads 108 that are slightly concave, as shown in FIGS. 6a and 6b, and which are the most common configurations for tooth heads 108. FIG. 5b shows the preferred sharpening tool 10 where body 26 is cylindrical and bottom face 22 is flat.

The shaft 12 is preferably a narrow cylinder attachable to a rotating power tool 36, such as a die grinder 48, as shown in FIG. 7b. In the preferred embodiment of the system 34, the shaft 12 has a cylindrical shape and is gripped by the collet 50 of die grinder 48 in the same manner as the collet 50 would grip a sanding disc. In other embodiments, however, the shaft 12 may take other art-recognized forms, such as having a hexagonal cross section for attachment to a quick connect hex driver, such as those found on drywall screw guns.

The preferred shaft 12 has a shaft length 42 of between 1.15 and 1.35 inches long, and preferably 1.25 inches. The preferred shaft 12 has a shaft diameter 30 of between 0.2 and 0.3 inches, and preferably 0.25 inches, which allows it to be gripped by collets 50 of most conventional handheld die grinders 48. As shown, for example, in FIG. 5b, the shaft 12 may include some ridging, reinforcement, or other structural support at its intersection with the center 24 of the bottom face 22 of the head 14. The shaft 12 is preferably attached to the head 14 by brazing. In some embodiments, however, the shaft 12 and head 14 are machined from a single bar of material. In embodiments in which the shaft is brazed to the head, the full length 44 of the sharpening tool 10 is preferably approximately 1.58 inches.

The head 14 of the sharpening tool 10 is a short wide cylinder when compared to the shaft 12. The head 14 has a body 26 having a round cross section with a top face 16 and a bottom face 22. The shaft 12 extends from the center 24 of the flat bottom face 22 of the head 14. As shown most clearly in FIG. 5a, the top face 16 has a face diameter 32 of between 0.75 and 1.25 inches, and preferably 0.98 inches.

Now referring to FIGS. 5c and 5d, side views of alternative embodiments of sharpening tool 10 are provided. In FIGS. 5c and 5d, bottom face 22 is a substantially conical surface 25 and body 26 is not cylindrical, as shown in FIG. 5b, but cone-shaped 27. When bottom face 22 is substantially conical 25, the narrowest part of the cone is always at the center 24 of the bottom face 22 from which shaft 12 extends. In FIG. 5c, the widest point 23 of the cone that forms the conical surface 25 that is bottom face 22 meets with top face 16. Top face 16 in FIG. 5c is flat and lacks the preferred concavity 28. In FIG. 5d, the widest point 23 is not where bottom face 22 meets top face 16, but instead there is a further extension out from the widest point 23 before bottom face 22 meets top face 16. The widest point 23 is never wider than face diameter 32.

Now referring to FIGS. 5e and 5f, embodiments of sharpening tool 10 where the distance between top face 16 and bottom face 22 is nominal are provided. In these embodiments, body 26 resembles a disc. In FIG. 5e, where top face 16 has convexity 28, body 26 resembles a bulging disc. In FIG. 5f, where top face 16 is flat, body 26 resembles a flat disc.

In FIGS. 5c and 5f, top face 16 is flat. These versions are best used with teeth 104 with flat teeth heads 108.

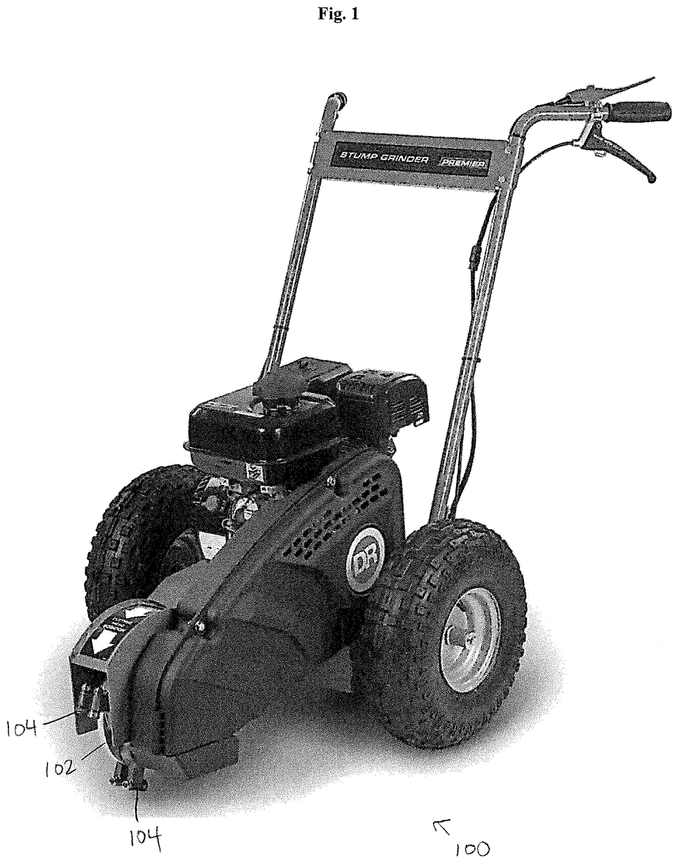

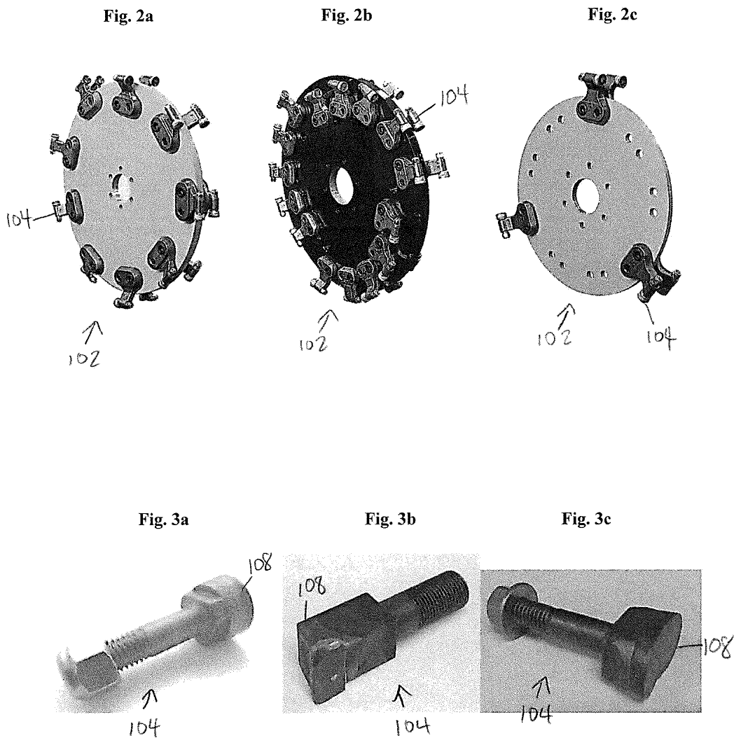

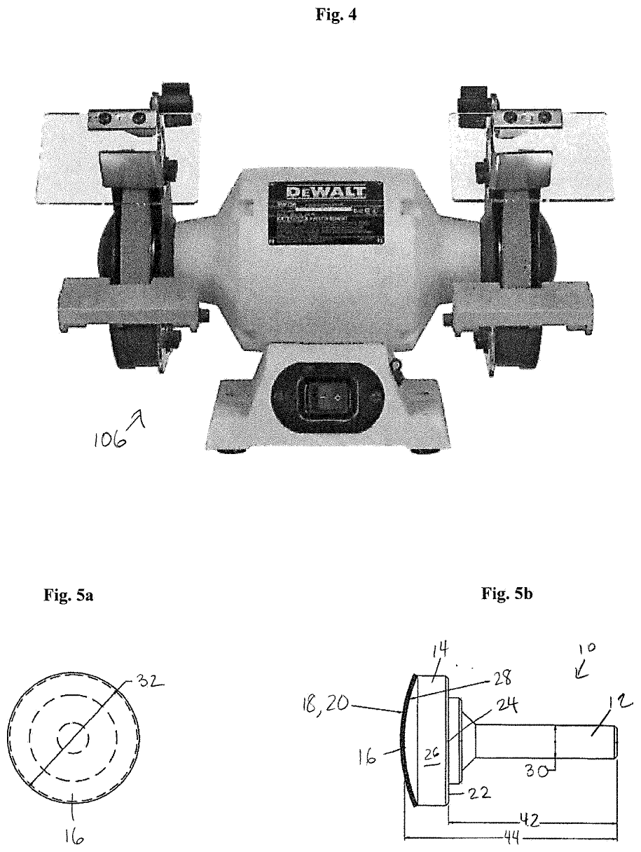

Now referring to FIGS. 6a and 6b, perspective views of sharpening tool 10 moving toward engaging with and engaging with a dull stump grinder tooth 104 are provided, respectively. Abrasive material 18 on top face 16 will engage with the surfaces of head 108 of tooth 104. Head 108 of this tooth 104 is slightly concave. As shown with the arrow in FIG. 6b, the convexity 28 of top face 16 enables contact between sharpening tool 10 and the concave part of head 108, in addition to the other surfaces of head 108. Using sharpening tool 10, the sharpening may be performed while the tooth 104 is still mounted on the wheel 108 (as shown, for example, in FIGS. 1 and 2a-2c). It has been found that using a random pattern during the sharpening is most successful in achieving the desired concave finish to the tooth head 108.

Now referring to FIG. 7a, a side view of a sharpening system 34 of the present invention is provided. Sharpening system 34 includes a rotating power tool 36 and a sharpening tool 10. A preferred rotating power tool 36 is a handheld drill 38 that includes a chuck 40, to which the shaft 12 of the sharpening tool 10 is attached. The chuck 40 of the drill 38 is the part that normally holds a drill bit and spins when the drill is in use. The shaft 12 is gripped by the chuck 40 just as the chuck 40 would grip a drill bit. In this way, the shaft 12 of the sharpening tool 10 is spun rapidly when the drill is in use, just as a drill bit would be.

Now referring to FIG. 7b, a side view of a sharpening system 34 of the present invention is provided. In this preferred embodiment, the rotating power tool 36 is a handheld die grinder 48 that includes a collet 50, to which the shaft 12 of the sharpening tool 10 is attached. Collet 50 may be tightened around shaft 12 to hold sharpening tool 10 firmly in place. Die grinder 48 is a preferred rotating power tool 36 for sharpening system 34 in part because it operates at a high speed of at least 10,000 RPM.

Prior art power tools such as the right angle die grinder sold under the tradenames NORTHERN TOOL+EQUIPMENT MILWAUKEE M12 may appear similar to the sharpening system 34 shown in FIG. 7b, but the round, spinning appendage for such prior art power tools is a fibrous buffing wheel, rather than a head with an abrasive surface, as in the present invention. The present invention would cause significant damage if used for applications for which such prior art power tools are used. Analogously, such prior art power tools would do nothing to sharpen anything in the applications for which the present invention is used.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A sharpening tool comprising:
a shaft dimensioned for attachment to a rotating power tool; and
a head extending from said shaft, said head comprising:
a top face coated in an abrasive material;
a bottom face, wherein said shaft extends from a center of said bottom face; and
a body extending between said top face and said bottom face.

2. The sharpening tool as claimed in claim 1, wherein said abrasive material is diamond grit.

3. The sharpening tool as claimed in claim 2, wherein said diamond grit is sized between 30 and 50 mesh.

4. The sharpening tool as claimed in claim 1, wherein said top face is domed convex away from said body.

5. The sharpening tool as claimed in claim 1, wherein said shaft is cylindrical and has a shaft diameter of between 0.2 and 0.3 inches.

6. The sharpening tool as claimed in claim 1, wherein said body is cylindrical.

7. The sharpening tool as claimed in claim 1, wherein said top face is round and has a face diameter of 0.75 to 1.25 inches.

8. The sharpening tool as claimed in claim 1, wherein said bottom face is a substantially conical surface and said body has a cone shape.

9. A sharpening system comprising:
a rotating power tool; and
a sharpening tool comprising:
a shaft dimensioned for attachment to a rotating power tool; and
a substantially cylindrical head extending from said shaft, said head comprising:
a top face coated in an abrasive material;
a bottom face, wherein said shaft extends from a center of said bottom face; and
a body extending between said top face and said bottom face.

10. The sharpening system as claimed in claim 9, wherein said rotating power tool is a handheld drill having a chuck.

11. The sharpening system as claimed in claim 9, wherein said abrasive material of said top face of said head of said sharpening tool is diamond grit.

12. The sharpening system as claimed in claim 11, wherein said diamond grit is sized between 30 and 50 mesh.

13. The sharpening system as claimed in claim 9, wherein said top face of said head of said sharpening tool is domed convex away from said round body.

14. The sharpening system as claimed in claim 9, wherein said shaft of said sharpening tool is cylindrical and has a shaft diameter of between 0.2 and 0.3 inches.

15. The sharpening system as claimed in claim 9, wherein said top face of said head of said sharpening tool is round and has a face diameter of 0.75 to 1.25 inches.

16. The sharpening system as claimed in claim 9, wherein said bottom face of said head of said sharpening tool is a substantially conical surface and said body has a cone shape.

17. The sharpening system as claimed in claim 9, wherein said rotating power tool is a handheld die grinder having a collet.
